(19) United States
(12) Patent Application Publication
(10) Pub. No.: US 2013/0315641 A1
(43) Pub. Date: Nov. 28, 2013

(54) IMAGE FORMING APPARATUS AND IMAGE FORMING METHOD

(71) Applicant: FUJI XEROX CO., LTD., Tokyo (JP)

(72) Inventors: Koichi WATANABE, Kanagawa (JP); Atsushi OGIHARA, Kanagawa (JP); Tetsuji OKAMOTO, Kanagawa (JP); Wataru SUZUKI, Kanagawa (JP); Shuichi NISHIDE, Kanagawa (JP); Masamichi KIMURA, Kanagawa (JP)

(73) Assignee: FUJI XEROX CO., LTD., Tokyo (JP)

(21) Appl. No.: 13/713,362

(22) Filed: Dec. 13, 2012

(30) Foreign Application Priority Data
May 23, 2012 (JP) 2012-117894

(51) Int. Cl. G03G 15/20

(52) U.S. Cl. CPC G03G 15/2007
USPC 399/341

(57) ABSTRACT

An image forming apparatus includes an image forming unit that forms an unfixed toner image on a recording medium; a transfer unit that carries a layer of the UV-curable resin thereon and transfers a UV-curable resin to the recording medium, on which the image forming unit has formed the unfixed toner image, by making the UV-curable resin contact the recording medium; and an irradiation unit that irradiates the UV-curable resin transferred to the recording medium with UV rays.

### CROSS-REFERENCE TO RELATED APPLICATIONS

This application is based on and claims priority under 35 USC 119 from Japanese Patent Application No. 2012-117894 filed May 23, 2012.

### BACKGROUND

### Technical Field

The present invention relates to an image forming apparatus and an image forming method.

### SUMMARY

According to an aspect of the invention, an image forming apparatus includes an image forming unit that forms an unfixed toner image on a recording medium; a transfer unit that carries a layer of a UV-curable resin thereon and transfers the UV-curable resin to the recording medium, on which the image forming unit has formed the unfixed toner image, by making the UV-curable resin contact the recording medium; and an irradiation unit that irradiates the UV-curable resin transferred to the recording medium with UV rays.

### BRIEF DESCRIPTION OF THE DRAWINGS

Exemplary embodiments of the present invention will be described in detail based on the following figures, wherein:

FIG. 1 schematically illustrates an image forming apparatus according to a first exemplary embodiment of the present invention;

FIG. 2 illustrates the image forming apparatus according to the first exemplary embodiment of the present invention;

FIG. 3 schematically illustrates a fixing unit;

FIG. 4 schematic illustrates a fixing process;

FIG. 5 illustrates an image forming apparatus according to a second exemplary embodiment of the present invention; and

FIG. 6 illustrates an image forming apparatus according to a modification of the second exemplary embodiment of the present invention.

### DETAILED DESCRIPTION

Hereinafter, exemplary embodiments of the present invention will be described with reference to the drawings.

### First Exemplary Embodiment

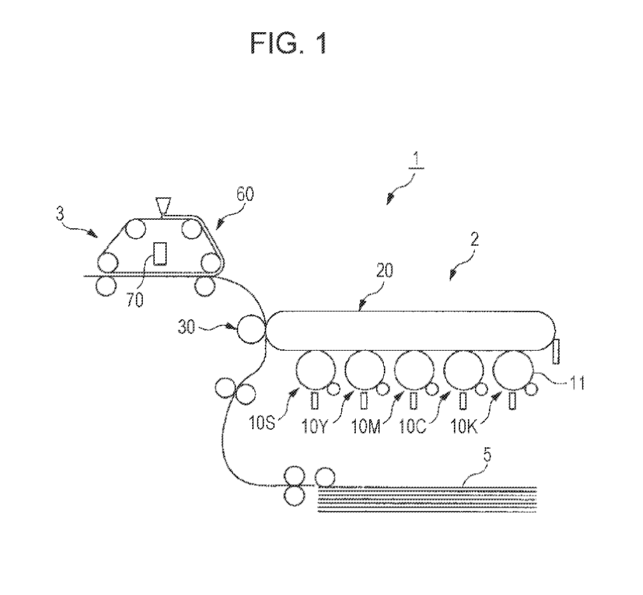

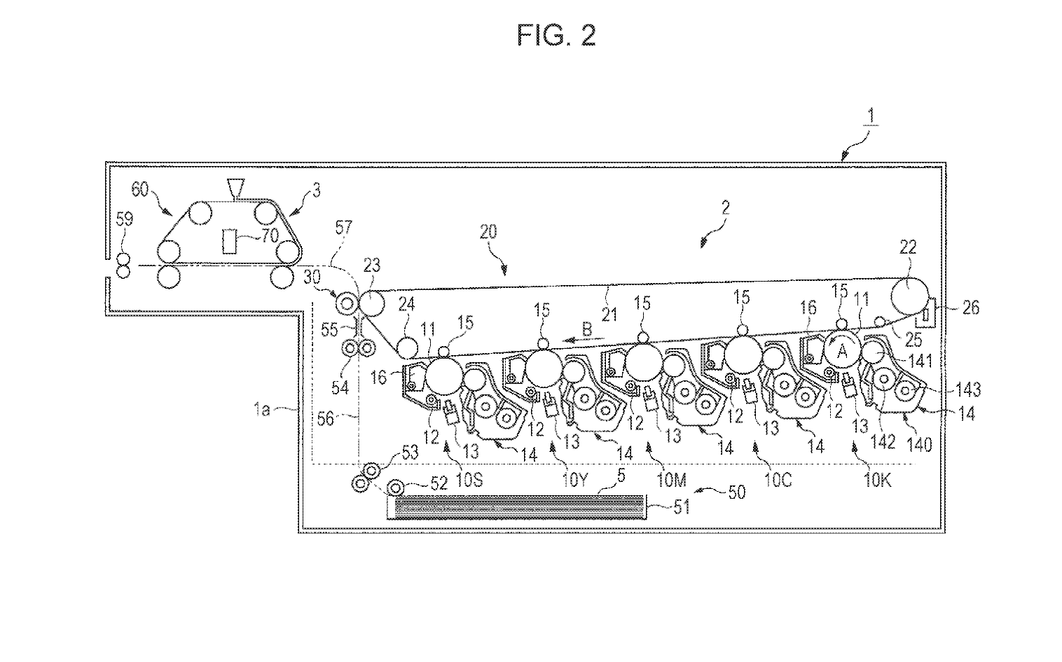

FIGS. 1 and 2 illustrate an image forming apparatus 1 according to a first exemplary embodiment. FIG. 1 schematically illustrates the image forming apparatus 1, and FIG. 2 illustrates the details of some parts (such as an image forming unit) of the image forming apparatus 1.

### Overall Structure of Image Forming Apparatus

The image forming apparatus 1 according to the first exemplary embodiment is, for example, a color printer that is capable of forming an image even on a recording medium that is heat sensitive, such as a sticky label, and on a recording medium that is not suitable for heat fixing. As illustrated in FIG. 1, the image forming apparatus 1 includes an image forming unit 2 and a fixing unit 3. The image forming unit 2 forms an unfixed toner image on a recording medium. The fixing unit 3 fixes the unfixed toner image formed on the recording medium by using a UV-curable resin. The image forming unit 2 includes image forming devices 10, an intermediate transfer device 20, and a sheet feeding device 50. The image forming devices 10 form toner images, which are developed using toners included in developers. The intermediate transfer device 20 carries the toner images formed by the image forming devices 10 and transports the toner images to a second transfer position, at which the toner images are second-transferred to the recording medium. The sheet feeding device 50 contains recording media, which are to be supplied to the second transfer position of the intermediate transfer device 20, and transports the recording media.

### Structure of Image Forming Apparatus

The image forming devices 10 include five image forming devices 10S, 10Y, 10M, 10C, and 10K, which respectively form toner images of specific color (S), yellow (Y), magenta (M), cyan (C), and black (K). The image forming devices 10 (S, Y, M, C, and K) are linearly arranged in a housing 1a. Except for the type of developer, the image forming devices 10 (S, Y, M, C, and K) have substantially the same structure as described below.

As illustrated in FIGS. 1 and 2, each of the image forming devices 10 (S, Y, M, C, and K) includes a photoconductor drum 11, which rotates, and the following devices, which are arranged around the photoconductor drum 11. The devices are a charger 12, an exposure device 13, a developing device 14, a first transfer device 15, and a drum cleaning device 16. The charger 12 charges a peripheral surface (image carrying surface) of the photoconductor drum 11 on which an image is to be formed to a predetermined potential. The exposure device 13 irradiates the charged surface of the photoconductor drum 11 with light modulated in accordance with image information (signal) and forms an electrostatic latent image (of a corresponding color) having a potential difference. The developing device 14 (S, Y, M, C, or K) forms a toner image by developing the electrostatic latent image using a toner included in a developer 4 of a corresponding color (S, Y, M, C, or K). The first transfer device 15 transfers the toner image to the intermediate transfer device 20. The drum cleaning device 16 cleans adherents such as toner remaining on the image carrying surface of the photoconductor drum 11 after first transfer.

The photoconductor drum 11 includes a base member and an image carrying surface formed on the outer peripheral surface of base member. The base member is grounded and has a hollow-cylindrical or a solid-cylindrical shape. A photoconductive layer (photosensitive layer) made of a photosensitive material is formed on the image carrying surface. The photoconductor drum 11 is rotated by a rotation device (not shown) in a direction indicated by arrow A.

The charger 12 is a contact charger including a roller that is in contact with the photoconductor drum 11. A charging voltage is applied to the roller of the charger 12. When the developing device 14 performs reversal development, the polarity of the charging voltage is the same as that of a toner supplied by the developing device 14.

The exposure device 13 irradiates the charged peripheral surface of the photoconductor drum 11 with light that is modulated in accordance with image information input to the image forming apparatus 1, and thereby forms an electrostatic latent image. The image information (signal) has been input to the image forming apparatus 1 through an appropriate device, and is transmitted to the exposure device 13 when forming a latent image.

As illustrated in FIG. 2, each of the developing devices 14 (S, Y, M, C, and K) includes a housing 140; and a development roller 141, two agitation-transport members 142 and 143, and a thickness regulating member (not shown), which are disposed in the housing 140. The housing 140 has an opening and a developer container. The development roller 141 carries the developer 4 to a developing region in which the development roller 141 faces the photoconductor drum 11. The agitation-transport members 142 and 143, which are screw augers or the like, agitate and transport the developer 4 so that the developer 4 passes the development roller 141. The thickness regulating member regulates the amount (the layer thickness) of developer carried by the development roller 141. A power supply (not shown) applies a development voltage between the development roller 141 of the developing device 14 and the photoconductor drum 11. The development roller 141 and the agitation-transport members 142 and 143 are rotated by rotation devices (not shown) in predetermined directions. Each of the developers 4 of five colors (S, Y, M, C, and K) is a two-component developer including a nonmagnetic toner and a magnetic carrier.

The first transfer device 15 is a contact transfer device including a first transfer roller that rotates in contact with the outer peripheral surface of the photoconductor drum 11 with an intermediate transfer belt 21 therebetween. A first transfer voltage is applied to the first transfer roller. A power supply (not shown) applies the first transfer voltage, which is a direct-current voltage having a polarity opposite to that of toner.

As illustrated in FIG. 2, the drum cleaning device 16 includes a cleaning plate and a conveying member. After first transfer has been finished, the cleaning plate contacts the peripheral surface of the photoconductor drum 11 with a predetermined pressure and removes adherents such as toner remaining on the peripheral surface. The conveying member, which is a screw auger or the like, recovers adherents such as toner that have been removed by the cleaning plate and conveys the adherents to a recovery system (not shown). A plate-shaped member (such as a blade) made of a rubber or the like is used as the cleaning plate.

As illustrated in FIG. 2, the intermediate transfer device 20 is disposed above the image forming devices 10 (S, Y, M, C, and K). The intermediate transfer device 20 includes the intermediate transfer belt 21, belt support rollers 22 to 25, a second transfer device 30, and a belt cleaning device 26. The intermediate transfer belt 21 rotates in a direction indicated by arrow B while passing first transfer positions between the photoconductor drums 11 and the first transfer devices 15 (first transfer rollers). The belt support rollers 22 to 25 rotatably support the intermediate transfer belt 21 from the inside of the intermediate transfer belt 21. The second transfer device 30 is disposed adjacent to the outer peripheral surface (image carrying surface) of a part of the intermediate transfer belt 21 that is supported by the belt support roller 23. The second transfer device 30 second-transfers toner images on the intermediate transfer belt 21 to a recording medium 5. The belt cleaning device 26 cleans the intermediate transfer belt 21 by removing adherents such as toner and paper powder remaining on the outer peripheral surface of the intermediate transfer belt 21 that has passed the second transfer device 30.

The intermediate transfer belt 21 is, for example, an endless belt made of a synthetic resin such as a polyimide resin or a polyamide resin, in which a resistance adjusting agent such as carbon black or the like is dispersed. The belt support roller 22 serves as a driving roller, the belt support roller 23 serves as a second-transfer backup roller, the belt support roller 24 serves as a tension roller, and the belt support roller 25 serves as a driven roller for maintaining the path of the intermediate transfer belt 21.

The second transfer device 30 is a contact transfer device including a second transfer roller that rotates in contact with the outer peripheral surface the intermediate transfer belt 21 at the second transfer position, at which the intermediate transfer belt 21 is supported by the belt support roller 23 of the intermediate transfer device 20. A second transfer voltage is applied to the second transfer roller. A power supply (not shown) supplies the second transfer voltage, which is a direct-current voltage having a polarity opposite to that of toner.

The sheet feeding device 50 is disposed below the image forming devices 10. The sheet feeding device 50 includes a sheet container 51 (or plural sheet containers 51), a feed roller 52, and a pair of separation rollers 53. The sheet container 51 contains a stack of recording media 5 of predetermined size and type. The feed roller 52 feeds the recording media 5 from the sheet container 51. The pair of separation rollers 53 separate the recording media 5 into single sheets and feeds the separated recording medium 5. As the recording medium 5, any sheet such as a plain paper sheet, a coated paper sheet, a label sheet sensitive to heat, a very thick sheet that is not suitable for heat fixing (for example, a sheet having a basis weight of 200 g/m² or more) may be used.

A sheet transport path 56 is disposed between the sheet feeding device 50 and the second transfer device 30. The sheet transport path 56 includes a transport guide 55 and a pair of sheet transport rollers 54 (or plural pairs of sheet transport rollers 54) that transport the recording medium 5, which has been fed by the sheet feeding device 50, to the second transfer position. The pair of sheet transport rollers 54, which are disposed directly before the second transfer position in the sheet transport path 56, serve as rollers (registration rollers) for adjusting the timing at which the recording medium 5 is transported.

As illustrated in FIG. 1, the fixing unit 3 is disposed on the upper left side of the second transfer position of the intermediate transfer device 20. The fixing unit 3 includes a transfer device 60 and an irradiation device 70. The transfer device 60 carries a layer of a UV-curable resin 61 thereon and transfers the UV-curable resin 61 to the recording medium 5, on which the image forming unit 2 has formed the unfixed toner image, by making the UV-curable resin 61 contact the recording medium 5. The irradiation device 70 irradiates the UV-curable resin transferred to the recording medium 5 with UV rays.

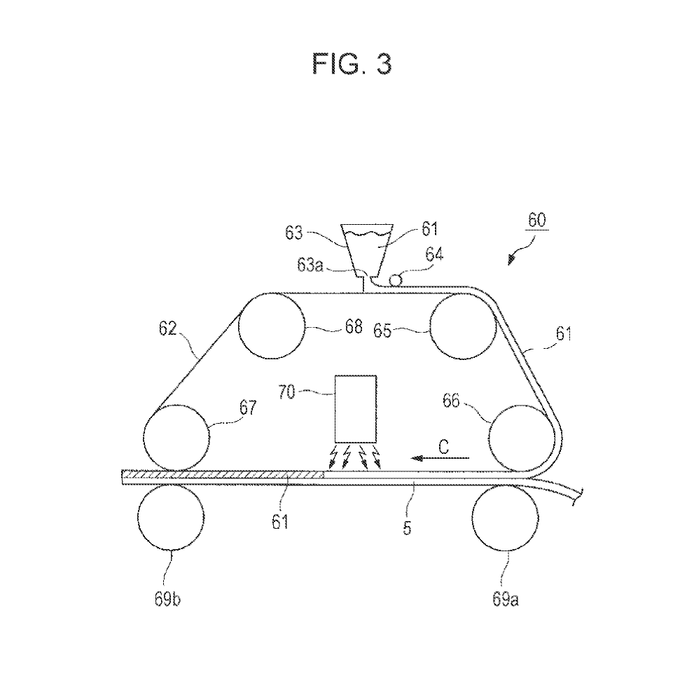

As illustrated in FIG. 3, the transfer device 60 includes a transfer belt 62, a supply container 63, a thickness regulating member 64, belt support rollers 65 to 68, and back support rollers 69a and 69b. The transfer belt 62 carries a layer of the UV-curable resin 61 and rotates in a direction indicated by arrow C while passing a fixing position at which a fixing operation is performed on the recording medium 5. The supply container 63 supplies the UV-curable resin 61 to the transfer belt 62. The thickness regulating member 64 regulates the layer thickness of the UV-curable resin 61 supplied to the transfer belt 62. The belt support rollers 65 to 68 rotatably support the transfer belt 62 by appropriately supporting the inner surface of the transfer belt 62. The back support rollers 69a and 69b support the back side of the recording medium 5 while the recording medium 5 is moving between the belt support rollers 66 and 67.

The transfer belt 62 is an endless belt made of, for example, a synthetic resin such as polyethylene terephthalate (PET), a polyimide resin (PI), or a polyamide-imide resin (PAI). It is preferable that the transfer belt 62 transmit UV rays, because the irradiation device 70 irradiates the UV-curable resin 61 with UV rays while the UV-curable resin 61 carried on the transfer belt 62 is in contact with the recording medium 5.

The supply container 63 contains the UV-curable resin 61 and continuously supplies an appropriate amount of the UV-curable resin 61 to a surface of the transfer belt 62 through an opening 63a formed in a bottom portion thereof. The thickness regulating member 64 regulates the layer thickness of the UV-curable resin using a coating bar, a coating die, a roller, or the like. The layer thickness of the UV-curable resin is in the range of, for example, about 0.1 to 100 μm.

The UV-curable resin 61 is composed of a UV-curable resin, which is the base resin, a surface tension regulator, a polymerization initiator, an additive, and the like.

Examples of the UV-curable resin include acryloyl morpholine, trimethylol propane tetraacrylate, polyethylene glycol 200 diacrylate, and polyethylene glycol 400 diacrylate. Examples of the UV-curable resin further include 2-(2-ethoxyethoxy)ethyl acrylate, stearyl acrylate, tetrahydrofurfuryl acrylate, lauryl acrylate, 2-phenoxyethyl acrylate, isodecyl acrylate, isooctyl acrylate, tridecyl acrylate, caprolactone acrylate, ethoxylated nonyl phenol acrylate, isobornyl acrylate, alkoxylated nonylphenol acrylate, alkoxylated 2-phenoxyethyl acrylate, tetrahydrofurfuryl methacrylate, isodecyl methacrylate, 3 butylene glycol diacrylate, 1,4-butanediol diacrylate, diethylene glycol diacrylate, 6-hexanediol diacrylate, tetraethylene glycol diacrylate, triethylene glycol diacrylate, tripropylene glycol diacrylate, ethoxylated (3) bisphenol A diacrylate, dipropylene glycol diacrylate, and alkoxylated hexane diol diacrylate.

Surface tension regulators are classified into acrylic agents, vinyl agents, silicone agents, and fluorocarbon resin agents. Silicone polyether acrylate is an example of silicone agents.

Polymerization initiators are classified into radical polymerization initiators, cationic polymerization initiators, and anionic polymerization initiators. Examples of the polymerization initiator include a mixture of oxyphenyl acetic acid 2-[2-oxo-2-phenylacetoxyethoxy]ethyl ester and oxyphenyl acetic acid 2-(2-hydroxyethoxy)ethyl ester.

The irradiation device 70 is disposed inside of the transfer belt 62 between the belt support rollers 66 and 67. While a layer of the UV-curable resin 61, which has been applied to the surface of the transfer belt 62, is moving in contact with a surface of the recording medium 5 on which an image has been formed, the irradiation device 70 irradiates the UV-curable resin 61 with UV rays. Various kinds of lamps, such as a mercury lamp, a xenon lamp, an excimer lamp, and an ultraviolet LED, may be used as a light source of UV rays.

### Operations of Entirety and Parts of Image Forming Apparatus

Hereinafter, a basic image forming operation performed by the image forming apparatus 1 will be described.

First, an operation of forming a full-color image, which is composed of toner images of four colors (Y, M, C, and K), by using the image forming devices 10 (Y, M, C, and K) will be described.

When the image forming apparatus 1 receives an instruction to perform an image forming operation (printing), the four image forming devices 10 (Y, M, C, and K), the intermediate transfer device 20, the transfer device 60, and the like are activated.

As illustrated in FIG. 2, in each of the image forming devices 10 (Y, M, C, and K), the photoconductor drum 11 rotates in a direction indicated by arrow A, the charger 12 charges a surface of the photoconductor drum 11 to a predetermined potential having a predetermined polarity (a negative polarity in the first exemplary embodiment). Next, the exposure device 13 irradiates the charged surface of the photoconductor drum 11 with light emitted in accordance with an image signal obtained by converting image information input to the image forming apparatus 1 into an image signal of a corresponding one of the color components (Y, M, C, and K), and thereby forms an electrostatic latent image for the color component having a predetermined potential difference on the surface of the photoconductor drum 11.

Next, the image forming devices 10 (Y, M, C, and K) supply toners of corresponding colors (Y, M, C, and K), which have been charged with a predetermined polarity (negative polarity), from the development rollers 141 to the electrostatic latent images for the color components formed on the photoconductor drums 11, and perform development by causing the toners to electrostatically adhere to the electrostatic latent images. Thus, the electrostatic latent images on the photoconductor drums 11 are developed into visible images formed of toners of corresponding four colors (Y, M, C, and K).

Next, when the color toner images formed on the photoconductor drums 11 of the image forming devices 10 (Y, M, C, and K) are transported to the first transfer positions, the first transfer devices 15 successively first-transfer the color toner images to the intermediate transfer belt 21 of the intermediate transfer device 20, which rotates in a direction indicated by arrow B, in such a way that the color toner images are superposed with one another.

After the first transfer has been finished, in each of the image forming devices 10, the charger 12 recharges adherents such as toner remaining on the surface of the photoconductor drum 11, and the drum cleaning device 16 cleans the surface of the photoconductor drum 11 by scraping the recharged adherents off the surface. Thus, the image forming devices 10 are set up to start the next image forming operation.

Next, in the intermediate transfer device 20, the intermediate transfer belt 21 rotates and carries the first-transferred toner images to the second transfer position. The sheet feeding device 50 feeds the recording medium 5 to the sheet transport path 56 so as to be in time with the image forming operation. In the sheet transport path 56, the pair of sheet transport rollers 54, which serve as registration rollers, feed the recording medium 5 to the second transfer position so as to be in time with a transfer operation.

At the second transfer position, the second transfer device 30 simultaneously second-transfers all the toner images on the intermediate transfer belt 21 to the recording medium 5. After the intermediate transfer device 20 has finished the second transfer operation, the belt cleaning device 26 cleans the surface of the intermediate transfer belt 21 by removing adherents such as toner remaining on the surface.

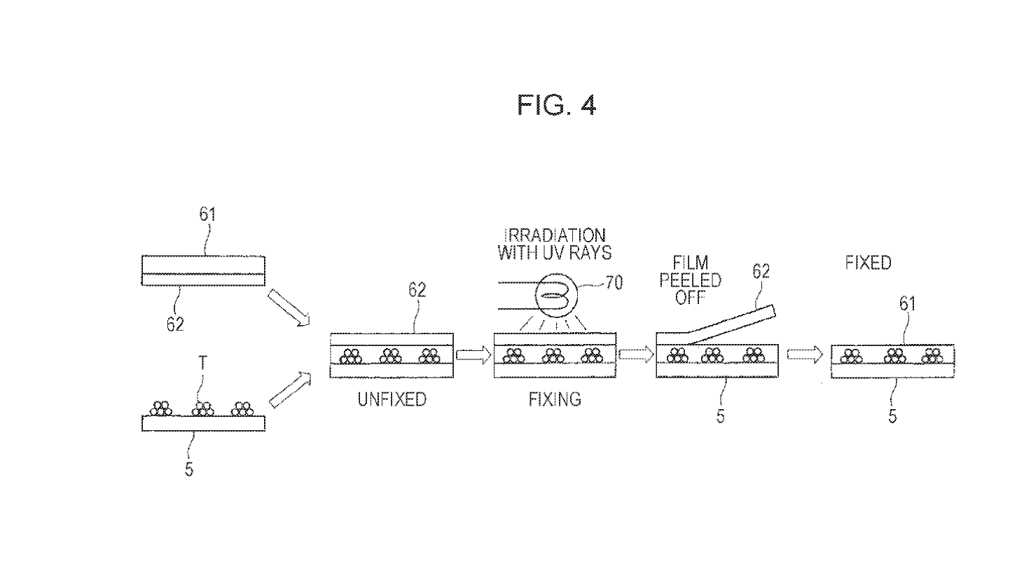

Next, the recording medium 5, to which the toner images have been second-transferred, is peeled off the intermediate transfer belt 21 and the second transfer device 30, and then transported to the fixing unit 3 along a transport path 57. As illustrated in FIG. 3, in the fixing unit 3, the transfer device 60 applies the UV-curable resin 61 to a surface of the transfer belt 62 so as to form a layer having a predetermined thickness. As illustrated in FIGS. 3 and 4, the transfer belt 62, to which the UV-curable resin 61 has been applied, is superposed on the recording medium 5, to which toner images have been second-transferred, so as to be in contact with the recording medium 5, and thereby the UV-curable resin 61 is transferred to a surface of the recording medium 5 to which the toner images have been transferred.

While the transfer belt 62 is moving in a state in which the transfer belt 62 is superposed on the recording medium 5, to which the toner images have been second-transferred, with the layer of the UV-curable resin 61 having a predetermined thickness therebetween, the irradiation device 70 irradiates the transfer belt 62 with UV rays, and thereby the UV-curable resin 61 becomes solidified and fixed to the recording medium 5. The UV-curable resin 61 has a property of dissolving polystyrene (PS) or the like, which is the base component of the toner. Even if the toner image is a full-color image composed of yellow (Y), magenta (M), and cyan (C), and other color components, while the toners of the toner image are moving in contact with the UV-curable resin 61, the toners become dissolved in and mixed with the UV-curable resin 61, which has not been solidified.

Subsequently, the recording medium 5 is peeled off the transfer belt 62 at a position at which the belt support roller 67 is disposed, and a fixed image, in which the toner images formed on the recording medium 5 are covered with the solidified UV-curable resin 61, is obtained. A pair of output rollers 59 output the recording medium 5 to, for example, an output tray (not shown) disposed outside of the housing 1a. When the recording medium 5 is peeled off the transfer belt 62, the surface of the UV-curable resin 61 assumes a shape similar to that of the surface of the transfer belt 62. If the surface of the transfer belt 62 is mirror finished or substantially mirror finished, the surface of the UV-curable resin 61 becomes glossy. If the surface of the transfer belt 62 is rough, the surface of the UV-curable resin 61 becomes nonglossy. In the present exemplary embodiment, when the UV-curable resin 61 solidifies, the recording medium 5 and the transfer belt 62 are in contact with each other with the UV-curable resin 61 therebetween, so that air (oxygen) does not exist in a region in which solidification occurs, and therefore the room for choice of the UV-curable resin 61 is increased.

As a result of the operation described above, the recording medium 5 on which a full-color image composed of the toner images of four colors has been formed is output.

Next, an operation performed by the image forming apparatus 1 when the image forming apparatus 1 additionally forms a toner image of the specific color S when performing, for example, the aforementioned basic image forming operation will be described.

In this case, first, the image forming device 10S performs an image forming operation the same the aforementioned image forming operation performed by each of the image forming devices 10 (Y, M, C, and K), and thereby a specific color toner image (S) is formed on the photoconductor drum 11 of the image forming device 10S. Next, as in the case of the image forming operation of forming the toner images of the four colors, the specific color toner image formed by the image forming device 10S is first-transferred to the intermediate transfer belt 21 of the intermediate transfer device 20 and then second-transferred from the intermediate transfer belt 21 to the recording medium 5 by the second transfer device 30 (together with the toner images of the other colors). Lastly, the fixing unit 3 performs a fixing operation on the recording medium 5, to which the specific color toner image and the toner images of the other colors have been second-transferred, and the recording medium 5 is output to the outside of the housing 1a.

Thus, a specific color toner image is formed so as to be superposed on a part or the entirety of the full-color image composed of the four color toner images on the recording medium 5, and the recording medium 5 is output. The specific color (S) toner is, for example, a white toner, which is used to increase the whiteness of the recording medium 5 by forming a layer on the entirety of the surface of the recording medium 5.

With the exemplary embodiment, the UV-curable resin 61 is applied to the surface of the transfer belt 62 with a predetermined layer thickness, and the UV-curable resin 61 is transferred to the surface of the recording medium 5 while the transfer belt 62, to which the UV-curable resin 61 has been applied, is superposed on the recording medium 5 so as to be in contact with the recording medium 5. As a result, the UV-curable resin 61 is transferred while preventing irregularities from being generated in the toner images formed on the recording medium 5.

The UV-curable resin 61 is solidified by irradiating the UV-curable resin 61 carried on the transfer belt 62 with UV rays while the transfer belt 62 is in contact with the recording medium 5. As a result, occurrence of irregularities in the toner images formed on the recording medium 5 is further prevented.

### EXAMPLE

A prototype of the fixing unit 3 including the transfer device and the irradiation device illustrated in FIG. 3 is made, and toner images formed on the recording medium 5 are fixed by using the UV-curable resin 61.

The UV-curable resin 61 used in this example includes ditrimethylol propane tetraacrylate (“AD-TMP” made by Shin Nakamura Chemical) as a UV-curable resin; silicone polyether acrylate (“TEGO Rad2200N” made by Evonik Tego Chemie) as a surface tension adjuster; and a mixture of oxyphnenyl acetic acid 2-[2-oxo-2-phenylacetoxyethoxy]ethyl ester and oxyphenyl acetic acid 2-(2-hydroxyethoxy)ethyl ester (“Irgacure 754” made by BASF) as a polymerization initiator. The solubility parameter (SP value) of ditrimethylol propane tetraacrylate used as the UV-curable resin is 9.7 (cal/cm³)^{1/2}. The SP value of polystyrene, which is the base component of toner is approximately 9.0 (cal/cm³)^{1/2}, which is close to 9.7, and therefore the UV-curable resin has a property of dissolving the toner.

The amounts of the UV-curable resin, the surface tension adjuster, and the polymerization initiator are respectively 20 (g), 0.6 (g), and 0.6 (g).

A plain paper sheet and a coated paper sheet are used as the recording medium. The layer thickness of the UV-curable resin 61 is about 50 μm.

As a result, peeling off of the solidified UV-curable resin 61 does not occur at all in a peel-off test called a “crease test”, which shows that the fixing strength with which the UV-curable resin 61 is fixed to the recording medium 5 is sufficiently high.

Regarding color reproduction of toner (secondary color), color reproduction is at substantially the same level as that of ordinary thermal pressing fixing method, and there is no problem also in the quality of a photographic image.

The surface of the recording medium 5 is a glossy surface, which is considered to be formed when the UV-curable resin 61 solidifies so as to assume a shape similar to a smooth surface of a transfer film.

Moreover, there is no problem even if UV rays are blocked by toner images because the UV-curable resin 61 in a region that is shielded by the toner images and is not irradiated with UV rays also solidifies.

In the fixing unit 3, only the irradiation device 70 consumes electric power except for electric power for driving of the transfer belt. Therefore, energy saving is achieved because the light source of the irradiation device 70 consumes electric power of only about 200 W.

### Second Exemplary Embodiment

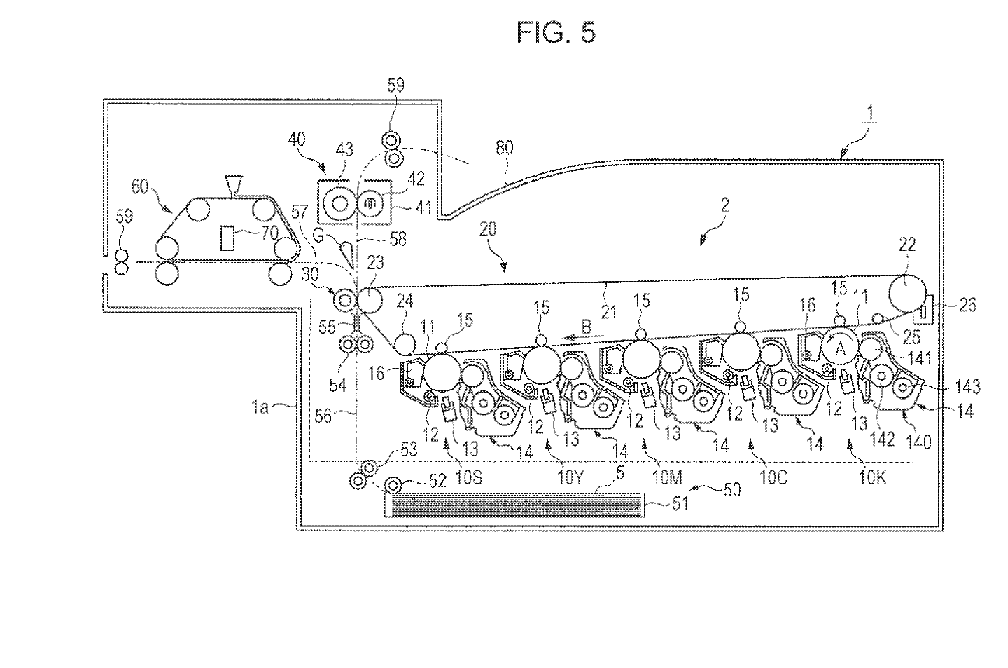

FIG. 5 illustrates an image forming apparatus 1 according to a second exemplary embodiment.

### Overall Structure of Image Forming Apparatus

As illustrated in FIG. 5, the image forming apparatus 1 according to the second exemplary embodiment includes a fixing unit 40 using an ordinary thermal pressing method, in addition to the fixing unit 3 using the UV-curable resin 61. By switching the transport path of the recording medium 5 using a switching gate G, it is also possible to perform a fixing operation using an ordinary thermal pressing method.

In the image forming apparatus 1, the fixing unit 40 is disposed above the second transfer position of the intermediate transfer device 20. The fixing unit 40 includes a housing 41; and a heat roller 42 and a pressure roller 43 having a drum-like shape, which are disposed in the housing 41. The housing 41 has an inlet and an outlet for the recording medium 5. The heat roller 42 rotates in a direction indicated by an arrow and is heated so that the surface temperature thereof is maintained at a predetermined temperature. The pressure roller 43 has an axis extending substantially parallel to the axis of the heat roller 42 and rotated by the heat roller 42 so as to be in contact with the heat roller 42 with a predetermined pressure. In the fixing unit 40, a predetermined fixing operation (heating and pressing operation) is performed in a fixing portion, which is a contact portion at which the heat roller 42 and the pressure roller 43 contact each other.

The image forming apparatus 1 includes the switching gate G above the second transfer position of the intermediate transfer device 20. The switching gate G switches the path of the recording medium 5 between the transport path 57 for transporting the recording medium 5 to the fixing unit 3 and a transport path 58 for transporting the recording medium 5 to the fixing unit 40. In FIG. 5, for convenience of drawing, the switching gate G is located adjacent to a surface of the recording medium 5 on which an image is formed. The switching gate G is capable of switching the transport path without impairing the image on the recording medium 5.

### Overall Operation of Image Forming Apparatus

Hereinafter, an image forming operation performed by the image forming apparatus 1 according to the second exemplary embodiment will be described.

When a user wants the image forming apparatus 1 to perform a fixing operation using an ordinary thermal pressing method instead of a method using the UV-curable resin 61, the user operates a user interface (not shown) and selects the fixing operation using the ordinary thermal pressing method. Then, the switching gate G is switched to the transport path 58 for transporting the recording medium 5 to the fixing unit 40.

As in the first exemplary embodiment, in the image forming apparatus 1, the four image forming devices 10 (Y, M, C, and K) form a full-color image composed of toner images of four colors (Y, M, C, and K), and the intermediate transfer device 20 second-transfers the full-color image to the recording medium 5.

Subsequently, the switching gate G switches the path of the recording medium 5 to the transport path 58, and the recording medium 5 is transported to the fixing unit 40. The fixing unit 40 fixes the unfixed toner image to the recording medium 5 by heating and pressing the recording medium 5, on which the unfixed toner image has been transferred, while the recording medium 5 passes through a contact portion at which the heat roller 42 and the pressure roller 43 are in contact with each other. The pair of output rollers 59 output the recording medium 5 to an output unit 80 disposed at an upper end portion of the housing 1a of the image forming apparatus 1.

With the second exemplary embodiment, it is possible to obtain an image fixed by using an ordinary thermal pressing method, because the image forming apparatus 1 according to the second exemplary embodiment includes the fixing unit 40 using the ordinary thermal pressing method in addition to the fixing unit 3 using the UV-curable resin 61. Therefore, it is possible to use the image forming apparatus 1 also in general offices and the like.

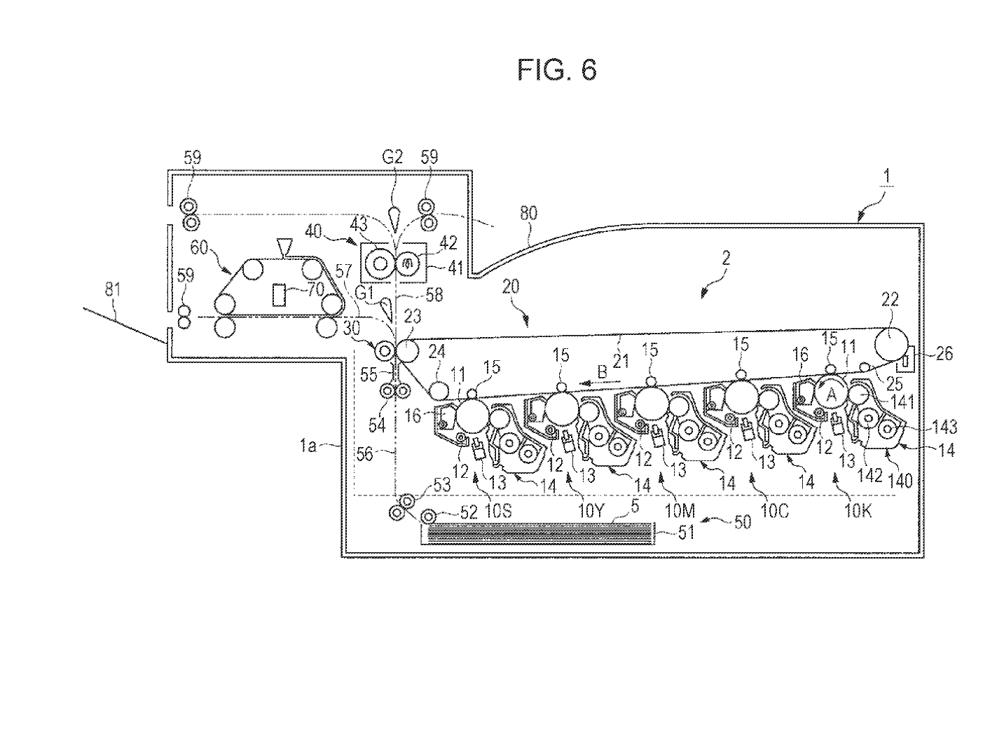

As illustrated in FIG. 6, the image forming apparatus 1 may further include a switching gate G2. In this case, the transport paths of a recording medium 5 on which an image has been fixed by the fixing unit 3 using the UV-curable resin 61 and a recording medium 5 on which an image has been fixed by the fixing unit 40 using an ordinary thermal pressing method are switched by using the switching gates G1 and G2, and thereby both recording media 5 may be output to the same output tray 81.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming unit that forms an unfixed toner image on a recording medium;
a transfer unit that carries a layer of a UV-curable resin thereon and transfers the UV-curable resin to the recording medium, on which the image forming unit has formed the unfixed toner image, by making the UV-curable resin contact the recording medium; and
an irradiation unit that irradiates the UV-curable resin transferred to the recording medium with UV rays.

2. The image forming apparatus according to claim 1,
wherein the irradiation unit irradiates the UV-curable resin with UV rays while the UV-curable resin carried on the transfer unit is in contact with the recording medium.

3. The image forming apparatus according to claim 1,
wherein the UV-curable resin has a function of dissolving a toner that forms the unfixed toner image.

4. The image forming apparatus according to claim 1, further comprising:
a fixing unit that fixes the unfixed toner image formed on the recording medium by heating the unfixed toner image.

5. The image forming apparatus according to claim 2, further comprising:
a fixing unit that fixes the unfixed toner image formed on the recording medium by heating the unfixed toner image.

6. The image forming apparatus according to claim 3, further comprising:
a fixing unit that fixes the unfixed toner image formed on the recording medium by heating the unfixed toner image.

7. An image forming method comprising:
forming an unfixed toner image on a recording medium;
carrying a layer of a UV-curable resin and transferring the UV-curable resin to the recording medium, on which the unfixed toner image has been formed, by making the UV-curable resin contact the recording medium; and
irradiating the UV-curable resin transferred to the recording medium with UV rays.
